(19) United States
(12) Patent Application Publication
(10) Pub. No.: US 2020/0149348 A1
(43) Pub. Date: May 14, 2020

(54) Stabilizing Safety Apparatus for Ladders

(71) Applicant: Raza H. Khwaja, Brampton (CA)

(72) Inventor: Raza H. Khwaja, Brampton (CA)

(21) Appl. No.: 16/680,558

(22) Filed: Nov. 12, 2019

Related U.S. Application Data
(60) Provisional application No. 62/767,480, filed on Nov. 14, 2018.

(51) Int. Cl. E06C 7/42

(52) U.S. Cl. CPC E06C 7/423

(57) ABSTRACT

A ladder stabilizing apparatus that is configured to provide improved stability of a ladder. A plurality of ladder stabilizing apparatus are secured to a desired ladder on opposing rails thereof. The ladder stabilizing apparatus includes an anchor member wherein the anchor member is releasably secured to the rail of the ladder. The lateral support members of the ladder stabilizing apparatus are secured to the anchor member and extend outward therefrom away from the ladder. A shank member is rotatably mounted within the lateral support members and facilitates the rotation of the leg members. The leg members comprise a plurality of telescopic sections that are adjustable with respect to each other. A base plate member is located at the end of the leg member distal to the shank member. Access rail members are secured to the top of the ladder on opposing rails.

### PRIORITY UNDER 35 U.S.C. SECTION 119(e) & 37 C.F.R. SECTION 1.78

This nonprovisional application claims priority based upon the following prior United States Provisional Patent Application entitled: Lateral Support and Stabilizing System for Ladders and the Like, application Ser. No. 62/767,480 filed Nov. 14, 2018, in the name of Raza H. Khwaja, which is hereby incorporated by reference for all purposes.

### FIELD OF INVENTION

The present invention relates generally to support and stabilizing system for ladders and other similar equipment, more specifically but not by way of limitation, a support and stabilizing safety system that is configured to have movable lateral support members that inhibit lateral movement of ladders and the like during use thereof and further having extended side support members above the uppermost rung so as to provide improved entry/exit of the ladder in some applications.

### BACKGROUND

Falls remain a leading cause of unintentional injury mortality nationwide, and 43% of fatal falls in the last decade have involved a ladder. Among workers, approximately 20% of fall injuries involve ladders. Among construction workers, an estimated 81% of fall injuries treated in U.S. emergency departments involve a ladder. To fully characterize fatal and nonfatal injuries associated with ladder falls among workers in the United States, the United States Center for Disease Control's National Institute for Occupational Safety and Health analyzed data across multiple systems. In 2017, work-related ladder fall injuries resulted in 113 fatalities and an estimated 15,460 nonfatal injuries were reported by employers. Additionally, an estimated 34,000 nonfatal injuries treated in emergency rooms were a result from ladder falls. Ladder falls represent a substantial public health burden of preventable injuries for workers. Because falls are the leading cause of work-related injuries and deaths in construction and ladder falls represent a large portion thereof it is important to provide ladder safety.

One problem with existing ladder technology is minimal lateral footprint provided by the typical ladder construction. Conventional ladders are typically sixteen inches to twenty-two inches in width. These ladders are configured to extended to as much as thirty feet which results in a length to width ratio that results in significant ladder stability issues. Common practice to address this issue include but are not limited to deploying an individual to hold a ladder while in use and utilizing a securing device such as but not limited to a rope. The aforementioned while sometimes effective are not able to be implemented in many situations and as a result the inherent risks of utilizing a ladder persists.

It is intended within the scope of the present invention to provide a ladder that includes lateral support arms that are positionable so as to provide improved lateral stability and further wherein the ladder of the present invention includes side support members that extend beyond the uppermost rung.

### SUMMARY OF THE INVENTION

It is the object of the present invention to provide a support and stabilizing safety system for ladders and other similar equipment that is constructed so as to provide improved lateral stability during use wherein the ladder includes opposing side support members and a plurality of rungs intermediate thereto.

Another object of the present invention is to provide a support and stabilizing safety system for ladders and other similar equipment that is configured to provide stability during utilization thereof wherein the side support members include a first extension and a second extension at the top end of the ladder.

A further object of the present invention is to provide a support and stabilizing system safety for ladders and other similar equipment that is constructed so as to provide improved lateral stability during use wherein the first extension and the second extension of the opposing side support members create an opening for entry and exit from the ladder when the ladder is engaged with an object such as but not limited to a rooftop.

Still another object of the present invention is to provide a support and stabilizing safety system for ladders and other similar equipment that is configured to provide stability during utilization thereof wherein the ladder includes a first lower lateral support arm that is operably coupled to one of the opposing side support members.

An additional object of the present invention is to provide a support and stabilizing safety system for ladders and other similar equipment that is constructed so as to provide improved lateral stability during use wherein the first lower lateral support arm includes a first portion and a second portion, the first portion extending perpendicularly outward from the side support member and the second portion extending angularly downward from the first portion.

Yet a further object of the present invention is to provide a support and stabilizing safety system for ladders and other similar equipment that is configured to provide stability during utilization thereof wherein the second portion of the first lower lateral support arm is both telescopically and rotatably coupled with the first portion.

Another object of the present invention is to provide a support and stabilizing safety system for ladders and other similar equipment that is constructed so as to provide improved lateral stability during use that further includes a second lower lateral support arm that is operably coupled to the lower end of the safety ladder opposite the first lower lateral support arm.

An alternate object of the present invention is to provide a support and stabilizing safety system for ladders and other similar equipment that is configured to provide stability during utilization thereof wherein the second lower lateral support arm is constructed identically to the first lower lateral support arm.

Still a further object of the present invention is to provide a support and stabilizing safety system for ladders and other similar equipment that is constructed so as to provide improved lateral stability during use that further includes a first upper lateral support arm that is secured to the upper end of the ladder.

An additional object of the present invention is to provide a support and stabilizing safety system for ladders and other similar equipment that is configured to provide stability during utilization thereof wherein the first upper lateral support arm is distally located from the first lower lateral support arm on the same side support member.

A further object of the present invention is to provide a support and stabilizing safety system for ladders and other similar equipment that is constructed so as to provide improved lateral stability during use wherein the first upper lateral support arm is constructed similarly to the first lower lateral support arm.

An alternative objective of the present invention is to provide a support and stabilizing safety system for ladders and other similar equipment that is configured to provide stability during utilization thereof that further includes a second upper lateral support arm that is secured to the upper end of the ladder.

Another object of the present invention is to provide a support and stabilizing system safety for ladders and other similar equipment that is constructed so as to provide improved lateral stability during use wherein the second upper lateral support arm is distally located from the second lower lateral support arm on the same side support member.

Yet a further object of the present invention is to provide a support and stabilizing safety system for ladders and other similar equipment that is configured to provide stability during utilization thereof wherein the second upper lateral support arm is constructed similarly to the second lower lateral support arm.

Another object of the present invention is to provide a support and stabilizing system safety for ladders and other similar equipment that is constructed so as to provide improved lateral stability during use wherein the safety ladder further includes at least one hook member configured to engage a portion of the structure on which the safety ladder is leaned thereagainst and wherein the at least one hook member inhibits rearward movement of the safety ladder.

An additional object of the present invention is to provide a support and stabilizing safety system for ladders and other similar equipment that is configured to provide stability during utilization thereof wherein the feet members of the safety ladder could be configured with non-slip material or suction cups so as to inhibit movement thereof.

Still a further object of the present invention is to provide a support and stabilizing safety system for ladders and other similar equipment that is constructed so as to provide improved lateral stability during use wherein the safety ladder is further configured with releasably secured ground anchors operable to engage the feet members of the present invention and secure to the ground.

An alternative object of the present invention is to provide a support and stabilizing safety system for ladders and other similar equipment that is configured to provide stability during utilization thereof wherein the lateral support arms could be configured to be integrally formed or releasably secured to the side support members.

To the accomplishment of the above and related objects the present invention may be embodied in the form illustrated in the accompanying drawings. Attention is called to the fact that the drawings are illustrative only. Variations are contemplated as being a part of the present invention, limited only by the scope of the claims.

### BRIEF DESCRIPTION OF THE DRAWINGS

A more complete understanding of the present invention may be had by reference to the following Detailed Description and appended claims when taken in conjunction with the accompanying Drawings wherein:

FIG. 1 is a view of the access rail member and anchor member of the present invention; and

FIG. 2 is a perspective view of an exemplary ladder with two ladder stabilizing apparatus of the present invention operably coupled thereto; and

FIG. 3 is a perspective view of a structure with two ladders leaned thereagainst wherein the two ladders have secured thereto a plurality of ladder stabilizing apparatus of the present invention.

### DETAILED DESCRIPTION

Referring now to the drawings submitted herewith, wherein various elements depicted therein are not necessarily drawn to scale and wherein through the views and figures like elements are referenced with identical reference numerals, there is illustrated a ladder stabilizing safety apparatus 100 constructed according to the principles of the present invention.

An embodiment of the present invention is discussed herein with reference to the figures submitted herewith. Those skilled in the art will understand that the detailed description herein with respect to these figures is for explanatory purposes and that it is contemplated within the scope of the present invention that alternative embodiments are plausible. By way of example but not by way of limitation, those having skill in the art in light of the present teachings of the present invention will recognize a plurality of alternate and suitable approaches dependent upon the needs of the particular application to implement the functionality of any given detail described herein, beyond that of the particular implementation choices in the embodiment described herein. Various modifications and embodiments are within the scope of the present invention.

It is to be further understood that the present invention is not limited to the particular methodology, materials, uses and applications described herein, as these may vary. Furthermore, it is also to be understood that the terminology used herein is used for the purpose of describing particular embodiments only, and is not intended to limit the scope of the present invention. It must be noted that as used herein and in the claims, the singular forms “a”, “an” and “the” include the plural reference unless the context clearly dictates otherwise. Thus, for example, a reference to “an element” is a reference to one or more elements and includes equivalents thereof known to those skilled in the art. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

References to “one embodiment”, “an embodiment”, “exemplary embodiments”, and the like may indicate that the embodiment(s) of the invention so described may include a particular feature, structure or characteristic, but not every embodiment necessarily includes the particular feature, structure or characteristic.

Referring now to the Figures submitted herewith, the ladder stabilizing safety apparatus 100 further includes a first lower support member 10 and second lower support member 20. The first lower support member 10 and second lower support member 20 are identically constructed and are configured to be mounted to opposing sides of an exemplary ladder 99. The first lower support 10 and second lower support member 20 are slidably secured to rails 98 of the ladder 99 utilizing anchor member 30. The anchor member 30 is configured to surroundably mount to the rails 98 in order to ensure a secure mounting of the first lower support member 10 and second lower support member 20. As will be further discussed herein, the anchor member 30 is positionable along the rails 98 of the ladder 99 so as to facilitate desired positioning of the first lower support member and second lower support member 20. The anchor member 30 is further configured to be operably coupled to the first upper support member 40 and second upper support member 50 so as to provide positionable mounting thereof to the rails 98 of the ladder 99. While not illustrated herein it should be understood within the scope of the present invention that the anchor member 30 could be operably coupled to alternate elements such as but not limited to hooks or pulleys in order to execute alternate tasks.

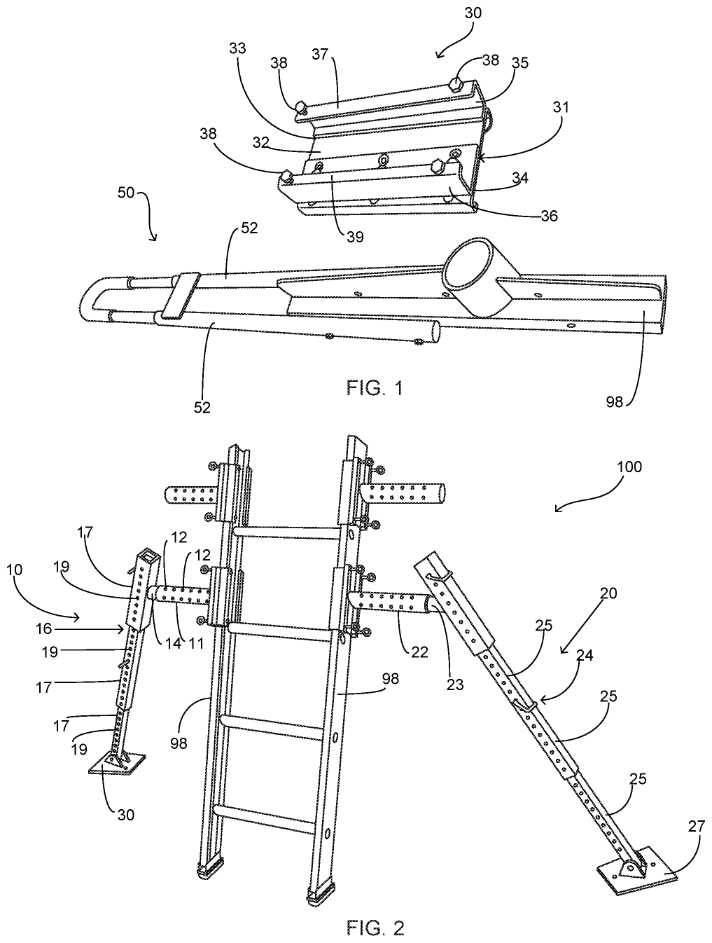

As shown in particular in FIG. 1, the anchor member 30 is formed from a body 31 wherein the body 31 is manufactured from a durable rigid material such as but not limited to metal. The body 31 is C-shaped so as to provide a secure mounting to the rails 98 of the ladder 99. The body 31 includes a rear plate 32 having an upper edge 33 and lower edge 34. Contiguously formed with the rear plate 32 proximate the upper edge 33 is the top plate member 35. The top plate member 35 is perpendicular with the rear plate 32 and extends outward therefrom. A bottom plate member 36 is contiguously formed with the rear plate 32 proximate the lower edge 34. The bottom plate member 36 is perpendicular to the rear plate 32 and extends outward therefrom. An upper lip member 37 is contiguously formed with the top plate member 35 distal to the rear plate 32. The upper lip member 37 is perpendicular to the top plate member 35 and extends downward therefrom. A lower lip member 39 is contiguously formed with the bottom plate member 36 distal to the rear plate 32. The lower lip member 39 is perpendicular to the bottom plate member 36 and extends upward therefrom. The lower lip member 39 and upper lip member 37 are parallel with the rear plate 32 and function to engage opposing sides of the rail 98 of the ladder 99 so as to provide a secure mounting of the anchor member 30. Secured to the anchor member 30 are fasteners 38 wherein the fasteners 38 are operable to releasably secure the anchor member 30 to a desired position on the rail 98 of the ladder 99. It should be understood within the scope of the present invention that the fasteners 38 could be configured on alternate embodiments. Furthermore, it should be understood within the scope of the present invention that while four fasteners 38 are illustrated herein, the anchor member 30 could have more or less than four fasteners 38. The anchor member 30 of the present invention is configured to be operably coupled to any type of ladder and positioned in various locations thereon.

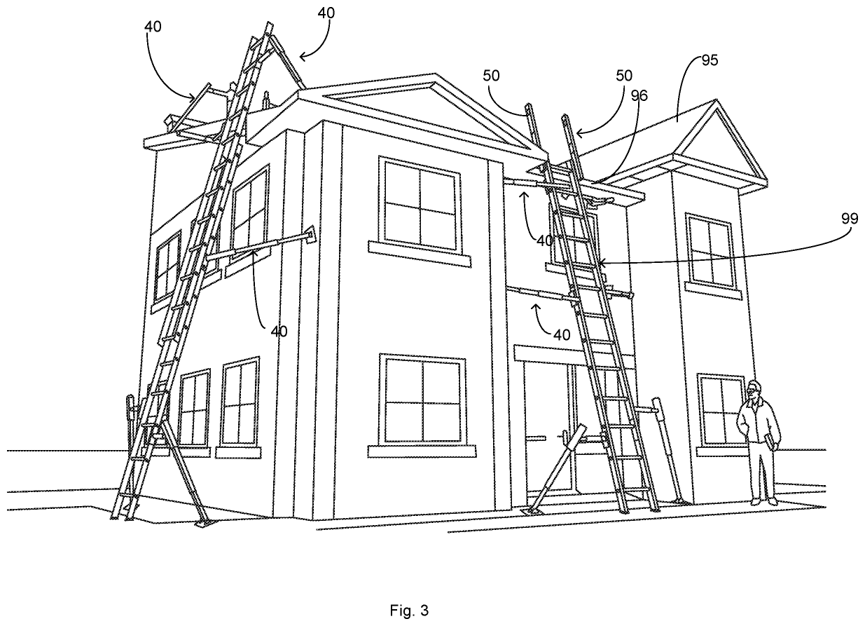

Referring in particular to FIG. 2 the first lower support member 10 and second lower support member 20 are identically constructed and are mounted on opposing sides of the ladder 99 utilizing the anchor member 30. The first lower support member 10 includes lateral support member 11. The lateral support member 11 is secured to the anchor member 30 utilizing suitable durable techniques in order to be either releasably secured or permanent in connection. By way of example but not by limitation, the lateral support member 11 could have a mounting plate(not illustrated herein) that could be configured to slidably engage a receptacle formed on the rear plate 32 opposite the lower lip member 39 and upper lip member 37. The lateral support member 11 in a preferred embodiment is tubular so as to facilitate positioning of the leg member 15 as is further discussed herein. The lateral support member 11 includes a plurality of apertures 12 journaled therein. The apertures 12 are operable to receive a pin or similar object(not illustrated herein) so as to engage and maintain shank member 14 in a desired position. The shank member 14 is rotatable within the lateral support member 11 so as to facilitate desired positioning of the first lower support member 10. As shown in FIG. 3 herein, the shank member 14 can be rotated within the lateral support member 11 so as to position the first lower support member 10 in various positions such as but not limited to the ground or the wall of a structure against which the ladder 99 is adjacent thereto.

The first lower support member 10 further includes leg member 16.

Leg member 16 is secured to shank member 14 and extends downward therefrom. The leg member 16 includes a plurality of sections 17 that are telescopic wherein each section 17 is slidably coupled with the adjacent section 17. The sections 17 are manufactured from a durable rigid material such as but not limited to square metal tubing. The sections 17 have formed therein a plurality of holes 19 that are configured to receive pin 18. The sections 17 are telescopically movable so as to adjust the length of the leg member 16 so as to facilitate secure engagement with a desired surface. The leg member 16 has secured thereto a base plate member 21. The base plate member 21 is square in shape and is hingedly attached to leg member 16 so as to ensure a flush engagement with a suitable support surface. The base plate member 21 functions to provide a distributed support engagement for the leg member 16 so as to ensure an operable engagement therewith that is stable. While the base plate member 21 is illustrated herein as being square in shape it is contemplated within the scope of the present invention that the base plate member 21 could be formed in alternate shapes and sizes. By way of example but not limitation, the base plate member 21 in a preferred embodiment could be trapezoidal in shape and further include grip members formed thereon.

The ladder stabilizing safety apparatus 100 further includes a second lower support member 20. The second lower support member 20 is constructed identically to the first lower support member 10 and is secured to the opposing side of the ladder 99. The second lower support member 20 includes a lateral support member 22, shank member 23 and leg member 24 having a plurality of telescopic sections 25. Lastly, a base plate member 27 is secured to the leg member 24 distal to the shank member 23.

The ladder stabilizing safety apparatus 100 further includes a plurality of upper support members 40. The upper support members 40 are constructed identically to the first lower support member 10 and second lower support member 20. The upper support members 40 are secured to the ladder 99 as required depending upon the extension of the ladder 99 and the need for stabilization thereof. The exemplary ladder 99 is an extension ladder wherein available models can extend to thirty feet or more. As the ladder 99 is extended the desirability to increase the stability thereof increases. The ladder stabilizing safety apparatus 100 provides deployment of alternate amounts of upper support members 40 as required. This facilitates not only engagement with a side wall of a building as shown herein in FIG. 3 but engagement with a portion of a roof so as to provide a more desirable bracing wherein the ladder 99 is not only braced laterally but in a forwards-rearwards direction.

It is contemplated within the scope of the present invention that the ladder stabilizing safety apparatus 100 could employ alternate quantities of upper support members 40. Furthermore, it should be understood within the scope of the present invention that the ladder stabilizing safety apparatus 100 could deploy as few as one support member or a plurality as shown in FIG. 3.

Referring now in particular to FIG. 1 the ladder stabilizing safety apparatus 100 further includes access rail members 50. The access rail members 50 are configured to be secured to the ends of the rails 98 of the ladder 99 and extend beyond a roof line 96 to which the ladder 99 is adjacent. The access rail members 50 being mounted on opposing rails 98 of the ladder 99 and extending beyond the roof line 96 provide a secure means for a user of the ladder 99 to transition from the ladder 99 to the roof 95. The access rail members 50 include support member 52 that is configured to engage opposing surfaces of the rail 98. It is contemplated within the scope of the present invention that the access rail members 50 could be constructed in alternate manners so as to perform the desired functionality as described herein. It is additionally contemplated within the scope of the present invention that the access rail members 50 could be constructed so as to be telescopic, collapsible and rotatable. Additionally, the access rail members 50 could have a securing device 30 operably coupled thereto. While the ladder 99 illustrated herein is a conventional extension ladder, it is contemplated within the scope of the present invention that the ladder stabilizing safety apparatus 100 could be operably coupled to alternate styles of ladders.

In the preceding detailed description, reference has been made to the accompanying drawings that form a part hereof, and in which are shown by way of illustration specific embodiments in which the invention may be practiced. These embodiments, and certain variants thereof, have been described in sufficient detail to enable those skilled in the art to practice the invention. It is to be understood that other suitable embodiments may be utilized and that logical changes may be made without departing from the spirit or scope of the invention. The description may omit certain information known to those skilled in the art. The preceding detailed description is, therefore, not intended to be limited to the specific forms set forth herein, but on the contrary, it is intended to cover such alternatives, modifications, and equivalents, as can be reasonably included within the spirit and scope of the appended claims.

What is claimed is:

1. A ladder stabilizing safety apparatus configured to be operably coupled to a ladder wherein the ladder stabilizing apparatus comprises:
an anchor member, said anchor member having a body, said body configured to be surroundably mounted to a rail of the ladder, said anchor member being releasably secured to the rail of the ladder;
a first support member, said first support member being operably coupled to said anchor member, said first support member further including a lateral support member, said lateral support member extending outward from said anchor member away from the ladder, said lateral support member being tubular in form, said first support member further including a leg member, said leg member being operably coupled to said lateral support member, said leg member being configured to be positioned so as to be biased against a support surface that is proximate the ladder.

2. The ladder stabilizing safety apparatus as recited in claim 1, and further including a shank member, said shank member having a first end and a second end, said first end of said shank member being inserted into said lateral support member, said second end of said shank member being secured to said leg member.

3. The ladder stabilizing safety apparatus as recited in claim 2, wherein said shank member is rotatable within said first lateral support member.

4. The ladder stabilizing safety apparatus as recited in claim 3, wherein said first lateral support member further includes a plurality of apertures journaled therein, said plurality of apertures configured to receive a pin through wherein the pin is configured to position said shank member.

5. The ladder stabilizing safety apparatus as recited in claim 4, wherein said leg member further includes a plurality of sections, said plurality of sections being telescopic.

6. The ladder stabilizing safety apparatus as recited in claim 5, and further including a base plate member, said base plate member being secured to said leg member, said base plate member secured to said leg member distal to said shank member.

7. The ladder stabilizing safety apparatus as recited in claim 6, and further including a first and second access rail members, said first and second access rail members mounted to opposite rails of the ladder, said first and second access rail members configured to extend beyond the ladder.

8. A ladder stabilizing safety apparatus configured to be operably coupled to a ladder wherein the ladder stabilizing apparatus comprises:
at least two anchor members, said at least two anchor members having a body, said body of said at least two anchor members having a rear plate, said rear plate having an upper edge and a lower edge, said body of said at least two anchor members further having a top plate, said top plate being contiguous with said upper edge, said top plate being perpendicular with said rear plate and extending outward therefrom, said body further including a bottom plate, said bottom plate being contiguous with said lower edge and extending outward therefrom, said bottom plate being parallel with said top plate, said at least two anchor members further including an upper lip member, said upper lip member being contiguous with said top plate, said upper lip member extending downward towards said bottom plate and being parallel with said rear plate, said at least two anchor members further including a lower lip member, said lower lip member contiguous with said bottom plate, said lower lip member extending upward towards said top plate, said lower lip member being parallel with said rear plate said at least two anchor members being releasably secured to the rail of the ladder;
two support members, said support member being operably coupled to each of said at least two anchor members, said two support members further including a lateral support member, said lateral support member extending outward from said at least two anchor members away from the ladder, said lateral support member being tubular in form and being hollow, said two support members further including a leg member, said leg member being operably coupled to said lateral support member, said leg member being configured to be positioned so as to be biased against a support surface that is proximate the ladder; and
wherein the ladder stabilizing apparatus is secured to the ladder on opposing rails thereof.

9. The ladder stabilizing safety apparatus as recited in claim 8, and further including a shank member, said shank member having a first end and a second end, said first end of said shank member being inserted into said lateral support member, said second end of said shank member being secured to said leg member.

10. The ladder stabilizing safety apparatus as recited in claim 9, wherein said lateral support member of each of said two support members further includes a plurality of apertures journaled therein, said apertures operable to receive a pin therethrough and operably couple with the shank member.

11. The ladder stabilizing safety apparatus as recited in claim 10, wherein said leg member of each of said two support members further include a plurality of sections, said plurality of sections being telescopic.

12. The ladder stabilizing safety apparatus as recited in claim 11, wherein said leg member of each of said two support members further include a base plate member, said base plate member secured to said leg member distal to said shank member.

13. The ladder stabilizing safety apparatus as recited in claim 12, wherein said shank member is rotatably mounted within said lateral support member so as to facilitate rotatable positioning of the at least two support members so as to engage the base plate member with a desired support surface.

14. The ladder stabilizing safety apparatus as recited in claim 13, and further including a first access rail member and a second access rail member, said first access rail member and said second access rail member being mounted to opposing rails of the ladder.

15. The ladder stabilizing safety apparatus as recited in claim 14, wherein the first access rail member and second access rail member extend beyond an upper end of the ladder.

16. The ladder stabilizing safety apparatus as recited in claim 15, wherein the first access rail member and second access rail member are mounted utilizing rail anchor members.

17. The ladder stabilizing safety apparatus as recited in claim 16, wherein the rail anchor members are constructed identically as the at least two anchor members.
